(19) United States
(12) Patent Application Publication
(10) Pub. No.: US 2025/0342377 A1
(43) Pub. Date: Nov. 6, 2025

(54) RANDOM ENTITY SELECTION WITH A FUZZY BLOCKLIST CAPABILITY

(71) Applicant: QOMPLX LLC, Reston, VA (US)

(72) Inventors: Jason Crabtree, Vienna, VA (US); Richard Kelley, Woodbridge, VA (US); David Park, Fairfax, VA (US); Jason Hopper, Halifax (CA)

(21) Appl. No.: 18/653,977

(22) Filed: May 3, 2024

(51) Int. Cl. G06N 7/02; G06F 7/58

(52) U.S. Cl. CPC G06N 7/02; G06F 7/588

(57) ABSTRACT

A system and methods for selecting a random entity with a fuzzy blocklist capability, comprising a range editor which acts on data received by either a plurality of databases or a possible address map; and an advanced random number generator. The range editor allows for breaking data into either desirable or blocked chunks which may be normalized and passed to the advanced random number generator. The advanced random number generator may select a random value from within a randomly selected chunk. Various methods for randomly selecting both a chunk and a value may be used to maximize the efficiency of the method and system.

### CROSS-REFERENCE TO RELATED APPLICATIONS

Priority is claimed in the application data sheet to the following patents or patent applications, each of which is expressly incorporated herein by reference in its entirety:
None.

### BACKGROUND OF THE INVENTION

### Field of the Invention

The disclosure relates to the field of random number generation, particularly to the random selection of an entity from a large sample size with a large number of undesirable entities.

### Discussion of the State of the Art

Random number generation is a process found throughout all areas of technology. Generally, random number generation is a straightforward process, especially when selecting a random number from a small sample. Issues arise when scaling random number generation into larger and larger sample sizes. For example, choosing a random number between 1 and 10,000,000, when half of the numbers are undesirable in the selection process can be time consuming and computationally expensive. One example of this issue is selecting a random Internet Protocol address in either IPv4 or IPv6.

With the explosion of the technical era, electronic devices each having their own IP address have become more and more prevalent. Originally, IPv4 was created as a part of a method for assigning numbers to electronic devices that access the internet. This process uses a 32-bit address format, allowing for approximately 4.3 billion possible unique IP addresses. With the exponentially growing number of devices that require IP addresses, a shift was made from IPv4 to IPv6. IPv6 allows for approximately 340 undecillion (3.4×10³⁸) possible IP addresses; a range of possible IP addresses that will likely never be fully exhausted. Port scanning is a commonly used method where software like Zmap and Masscan generate a number for all possible IP addresses and convert the generated numbers into corresponding IP addresses. While generating a random IP address is simple, the challenge arises when having to factor in large ranges of IPs that should not be scanned for any number of reasons. The process for selecting an IP address functionally becomes: generate an IP within the IPv4 and IPv6 ranges, check to see if the generated IP falls within any specified ranges that are not to be scanned, loop until an acceptable IP is found. This process can be incredibly slow, especially when scanning the IPv6 range where a high number of large chunks of IP addresses are not yet allocated.

What is needed is a system that can quickly scan and select from a large range of entities while preventing designated ranges of entities from being considered in the selection process while being computationally simple enough to operate at very high frequencies.

### SUMMARY OF THE INVENTION

Accordingly, the inventor has conceived, and reduced to practice, a system and method for randomly selecting an entity with a fuzzy blocklist capability. A fuzzy blocklist compares incoming data against predefined keywords, rules, or other criteria allowing some entities to be excluded from the selection process.

In one embodiment, the system and method for selection of a random entity with a fuzzy blocklist capability acts as a way of efficiently pulling a single, random IP address. The ability to block out ranges of IP addresses that are not desirable serves as a way to maximize the efficiency of the system while allowing for the perturbation of randomly selected IP addresses to be restricted and adapted to specific application needs. Scanning and selecting random IP addresses has a variety of real-world applications including cybersecurity, military defense, and simulations. Additionally, this method and system may be adapted to efficiently parse heavily populated sets of entities or sparsely populated sets of entities.

In one aspect of the invention, a system for selecting a random entity with a fuzzy blocklist capability, comprises: a computing system comprising a memory and a processor; a range editor a first plurality of programming instructions stored in the memory which, when operating on the processor, causes the computing system to: receive data from a plurality of databases, the plurality of databases comprising at least a plurality of entities; index the plurality of entities with an index engine into a plurality of chunks comprising a start value, an end value, and a length which is the difference between an absolute value of the difference between the start value and the end value; separate the plurality of chunks with a data chunker into either a plurality of desired chunks or a plurality of blocked chunks; pass the plurality of desired chunks into a data normalization engine which normalizes the lengths of each desired chunk into normalized lengths; send the plurality of desired chunks and their normalized lengths to an advanced random number generator which selects a random desired chunk with a selection probability based on its normalized length; select a value from the selected random desired chunk using a value selector, is disclosed.

According to an aspect of an embodiment, the system further comprises a potential address map which receives entities directly or from the plurality of databases and creates a map of potential entities according to a plurality of rules.

According to an aspect of an embodiment, the index engine indexes the map of potential entities into the plurality of chunks.

According to an aspect of an embodiment, the random number generator selects a random desired chunk with a probability based on its normalized length.

In another aspect of the invention, a method for selecting a random entity with a fuzzy blocklist capability, comprises the steps of: (a) receiving data from a plurality of databases, the plurality of databases comprising at least a plurality of entities; (b) indexing the plurality of entities with an index engine into a plurality of chunks comprising a start value, an end value, and a length which is the difference between an absolute value of the difference between the start value and the end value; (c) separating the plurality of chunks with a data chunker into either a plurality of desired chunks or a plurality of blocked chunks; (d) passing the plurality of desired chunks into a data normalization engine which normalizes the lengths of each desired chunk into normalized lengths; (e) sending the plurality of desired chunks and their normalized lengths to an advanced random number generator which selects a random desired chunk; (f) selecting a value from the selected random desired chunk using a value selector, is disclosed.

### BRIEF DESCRIPTION OF THE DRAWING FIGURES

The accompanying drawings illustrate several aspects and, together with the description, serve to explain the principles of the invention according to the aspects. It will be appreciated by one skilled in the art that the particular arrangements illustrated in the drawings are merely exemplary and are not to be considered as limiting of the scope of the invention or the claims herein in any way.

FIG. 1 is a diagram of an exemplary system architecture for a system for randomly selecting an entity with a fuzzy blocklist capability.

FIG. 2 is a diagram of an exemplary data chunker showing how a random chunk of entities can either be included or blocked.

FIG. 3 is a diagram of an exemplary system architecture for a system for randomly selecting an entity where a range of entities can be scanned and scored for later selection.

FIG. 4 is a flow diagram showing a general flow of the process used to randomly select a chunk of entities.

FIG. 5 is a process diagram showing a general flow of the process used to randomly select an entity within a chunk.

FIG. 6 is a block diagram illustrating how one embodiment of a continuous index method may randomly select an entity.

FIG. 7 illustrates an exemplary computing environment on which an embodiment described herein may be implemented.

### DETAILED DESCRIPTION OF THE INVENTION

The inventor has conceived, and reduced to practice, a system and method for random entity selection with a fuzzy blocklist capability.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Conceptual Architecture

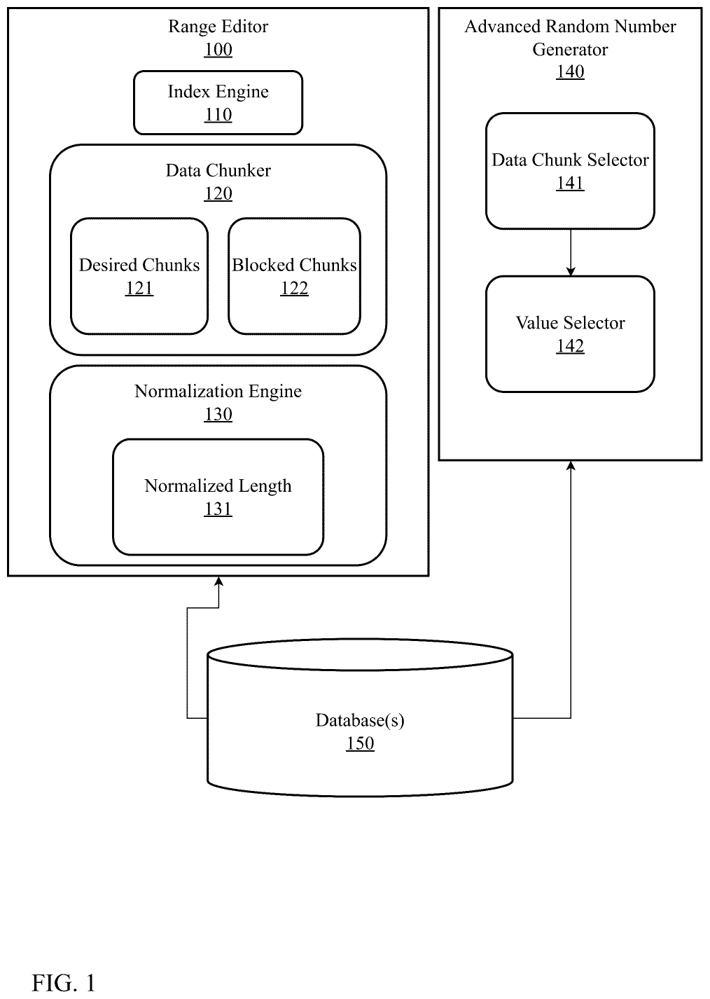

FIG. 1 is a block diagram illustrating a system for randomly selecting an entity with a fuzzy blocklist capability, according to a preferred embodiment of the invention. According to the embodiment, a range editor 100 pulls entities from one or more databases 150. An index engine 110 compiles and indexes desired entities into a list with a set start and end point. The start and end points are variable and can be adjusted based on factors such as computational capability and preferred sample size. After a list of entities is indexed, a data chunker 120 splits the entities into either desired chunks 121 or blocked chunks 122. Desired chunks 121 may be based on preference and target IP address audience. In one embodiment, blocked chunks 122 may include ranges of entities that are reserved for private use, have not yet been allocated, or have opted-out of being scanned. After desired chunks 121 are determined, the chunks are passed through a data normalization engine 130. In one embodiment, the data normalization engine 130 calculates the normalized length of each desired chunk 131. This may be done by dividing a length of a specific desired chunk by the sum of all lengths of all desired chunks 121. A normalized length is the difference between an absolute value of the difference between a desired chunk's 121 start value a desired chink's 121 end value. As the data normalization engine 130 is a normalization tool, the sum of all normalized lengths for all specific desired chunks should total 1.0.

To randomly select an entity within a chunk, the system may use an advanced random number generator 140. The advanced random number generator 140 uses a data chunk selector 141 that randomly selects an included chunk based on a probability density of the normalized lengths. The larger a chunk's normalized length, the larger the probability of being selected by the data chunk selector 141. The advanced random number generator 140 may use a number of known functions or methods to make a random selection. One embodiment may use a numpy.random.choice function found within Package Numpy to make a random selection. Other embodiments may manually generate a value between 0 and 1.0, including 0 and excluding 1.0, and assign it to a variable. The variable may be compared to the normalized length values of selected chunks until a desired chunk is reached. Additional embodiments may utilize a continuous index set method to make a random selection. The advanced random number generator 140 may use a single method or multiple methods together to maximize the efficiency of making a random chunk selection. Once the data chunk selector 141 has randomly selected a desired chunk, a value selector 142 randomly selects an IP address within the selected chunk.

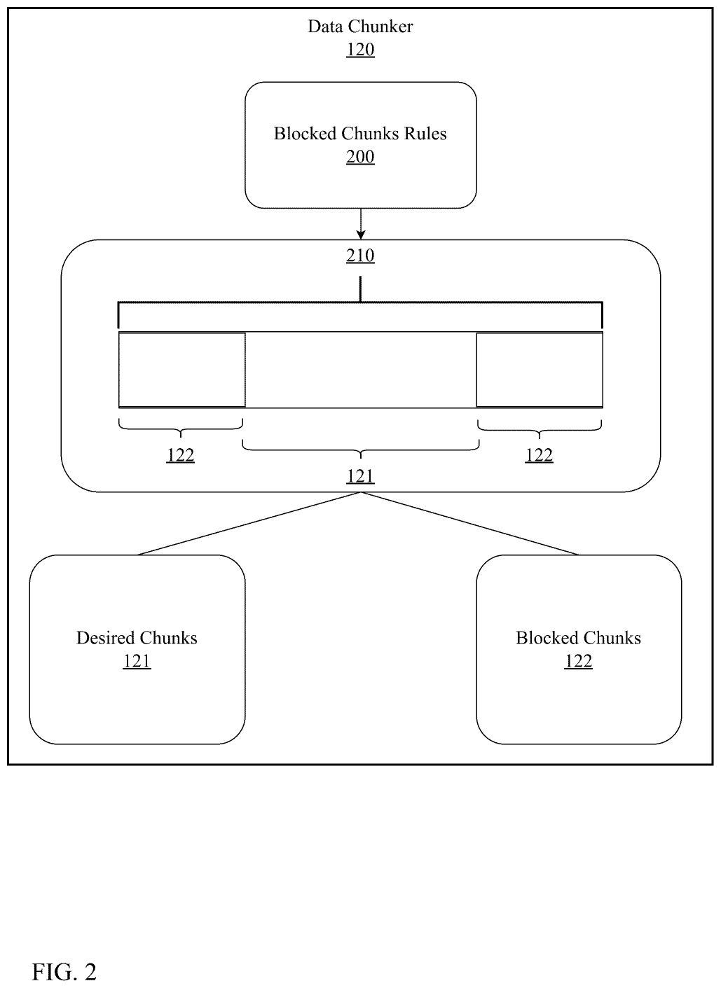

FIG. 2 is a diagram illustrating how data chunker 120 can divide chunks according to a plurality of blocked chunk rules 200. The data chunker breaks apart a total range of entities 210 into either desired chunks 121 or blocked chunks 122. Any plurality of portions of the total range of entities 210 may be broken into desired chunks 121 or blocked chunks 122, depending on the selected blocked chunks rules 200.

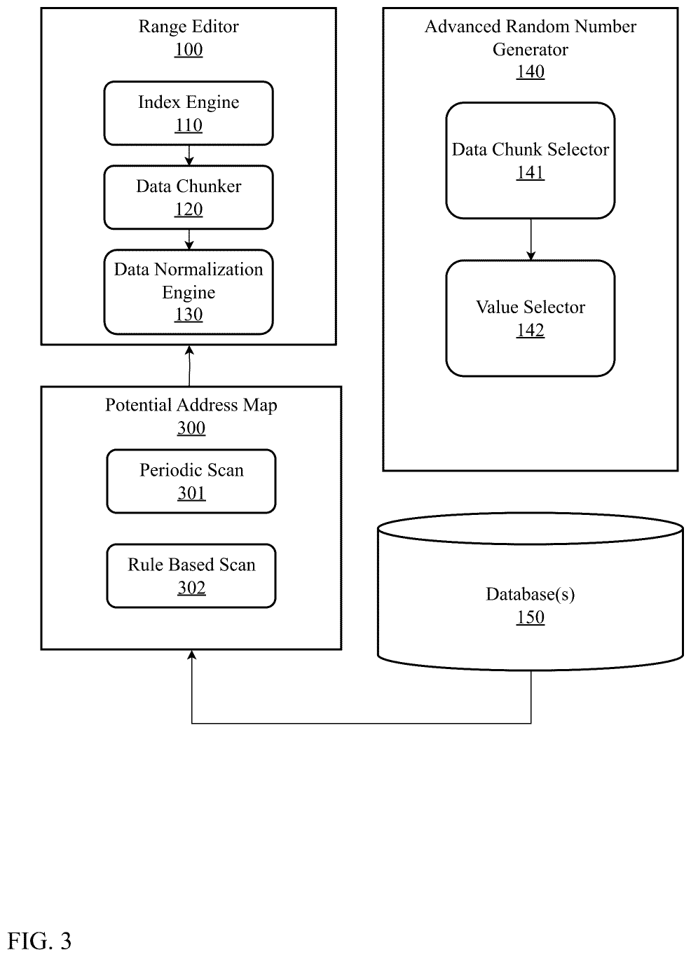

FIG. 3 is a block diagram illustrating a system for randomly selecting an entity with a fuzzy blocklist capability where the range of all possible entities are mapped by a potential address map 300 before being modified by the range editor 100. The potential address map 300 pulls possible entities from a plurality of databases 150 and scans the range of entities according to a selected rule. A scan may be triggered periodically through a periodic scan 301, or a rule-based scan 302 may be designated to force scans outside of a specified period. Scans are performed for the purposes of determining which range of entities are desirable or which are to be blocked. In one embodiment of the invention, Rule-based scan 302 may leverage scoring evidence such as potential addresses, assets, or other parameters within considered ranges to determine what data points merit a fuzzy blocklist addition. Rule-based scan 302 may also be used in tandem with a periodic scan 301.

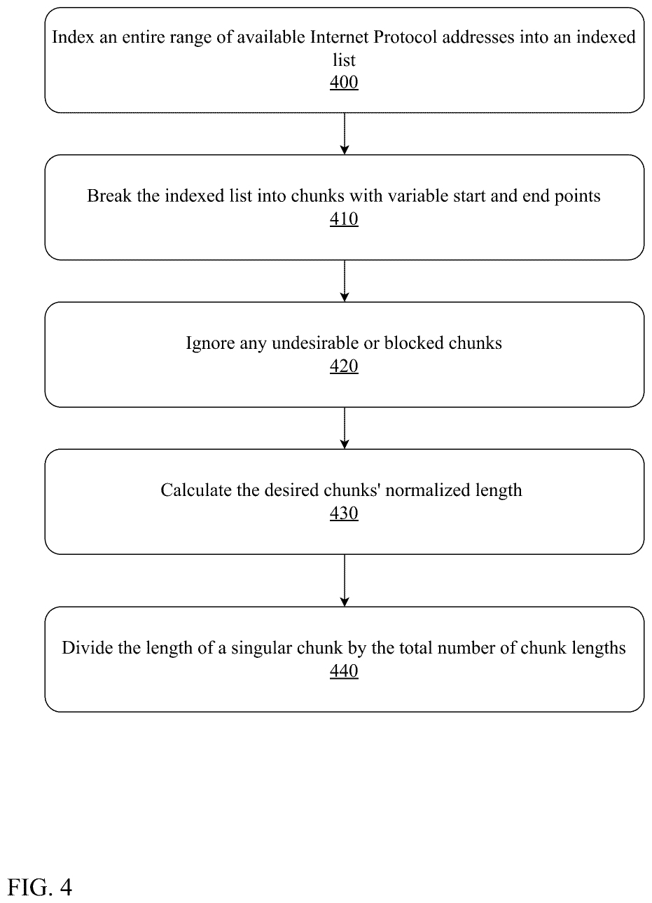

FIG. 4 is a flow diagram illustrating an exemplary method for selecting a random chunk from a list of available entities. Regarding the steps in this diagram, there is no strict requirement for the steps to be in this particular order. In a first step 400, index an entire range of available entities into an indexed list. In step 410, break the indexed list into chunks with variable start and end points. The start and end points may be selected into chunks are broken into either desirable chunks or blocked chunks. In step 420, ignore any undesirable or blocked chunks. In step 430, calculate the desired chunks' normalized length. In step 440, a normalized length may be calculated by dividing the length of a singular chunk by the total number of chunk lengths. Because the value is normalized, the sum of all normalized lengths should sum to 1.0.

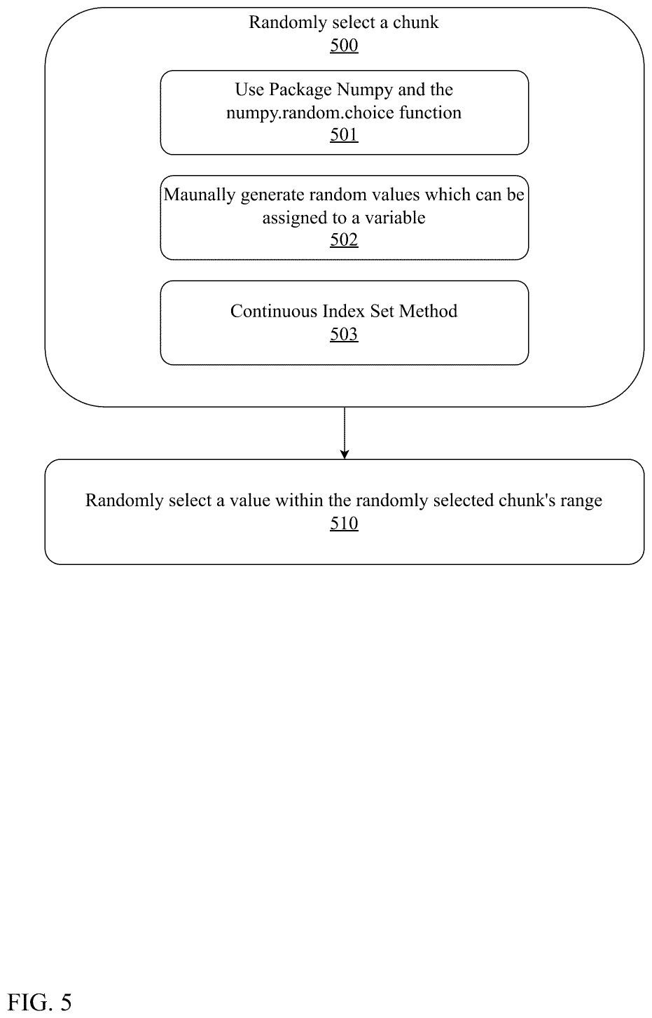

FIG. 5 is a flow diagram illustrating an exemplary method for selecting a random value from a desired chunk. In a first step 500, randomly select a chunk. Various methods for randomly selecting a chunk exist and an embodiment may include any of the following. One way to select a random chunk is through the use of Package Numpy and the numpy.random.choice function 501. Another way to select a random chunk is by manually generating random values which can be assigned to a variable 502. Additionally, a continuous index set method 503 may be used to randomly select an entity. This method may be useful when there are very short chunks-when the space containing desirable chunks is sparse compared to undesirable chunks, method 501 and 502 may be inefficient. For example, in a large space such as IPv6 where there are only a relatively tiny number allocated addresses, many of the desired chunks may only contain a single IP address. This method may be used in tandem with the potential address map 300. In cases with lots of empty space, this method would allow for mapping a large and sparse vector onto a continuously connected vector with no empty elements which each element points to a non-null entity in the large and sparse space. Methods 501, 502, and 503, are neither mutually exclusive nor exhaustive. Additional methods for the random selection of a chunk exist and a plurality of methods may be used to maximize efficiency.

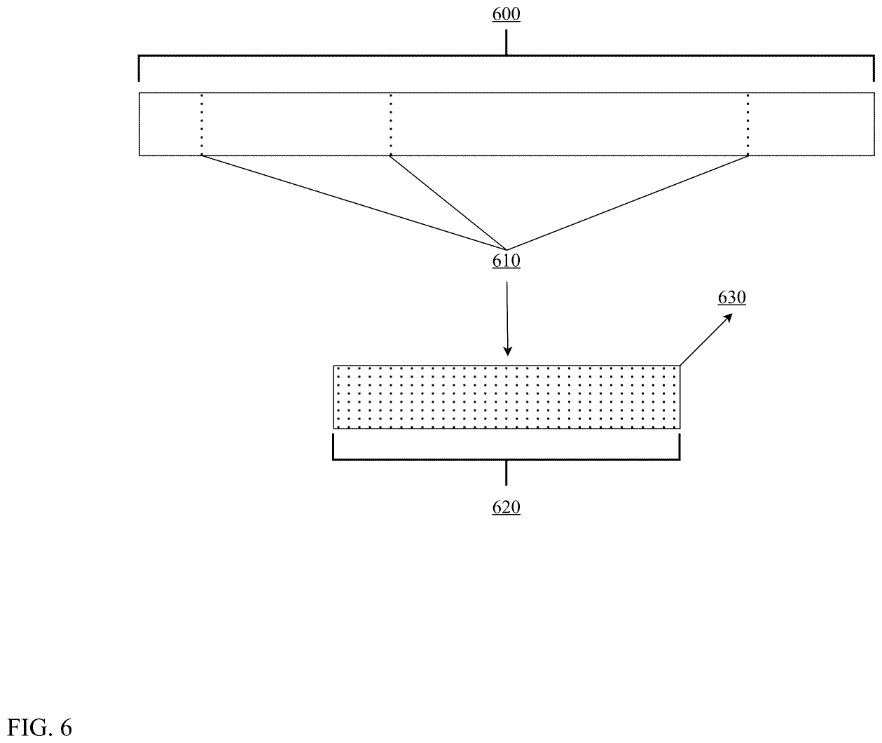

FIG. 6 is a block diagram illustrating how one embodiment of the continuous index method 503 may work. First, a range of all possible entities 600 would be defined based on preferences. In one embodiment, range 600 may be expansive but sparsely populated by non-null entities 610. When the entire range of 600 is mostly empty, it may be inefficient to chunk the entire range into desirable or undesirable chunks, especially when non-null entities 610 may only be singlets or doublets within their space. Singlets or doublets are non-null entities 610 that occur one or two at a time, respectively. Rather than chunk single and double non-null entities 610, the continuous index method 503 may store all non-null entities 610 into a new vector or array 630 with a total length 620 which corresponds to the total number of non-null entities 610. Once all non-null entities are mapped into the new vector or array 630, each singlet or doublet may be indexed where the index in the new vector or array 630 points to a corresponding non-null vector in the range of all possible entities 600. From there, an index may be randomly selected in the new vector or array 630 and it will always point to a corresponding non-null entity. In another embodiment, the continuous index method 503 may exclude some non-null entities 610 based on a specified rule. For example, the continuous index method 503 may exclude government, private, or undesirable entities from the new vector or array 630 even though those entities may be non-null.

In another embodiment, the continuous index method 503 may be used in tandem with either method 501 or 502. The continuous index method 503 may pertain to a range of all nun-null singlet or doublet entities 610 and a different method may pertain to all chunks of non-null entities where each chunk contains a plurality of larger non-null entities.

### Exemplary Computing Environment

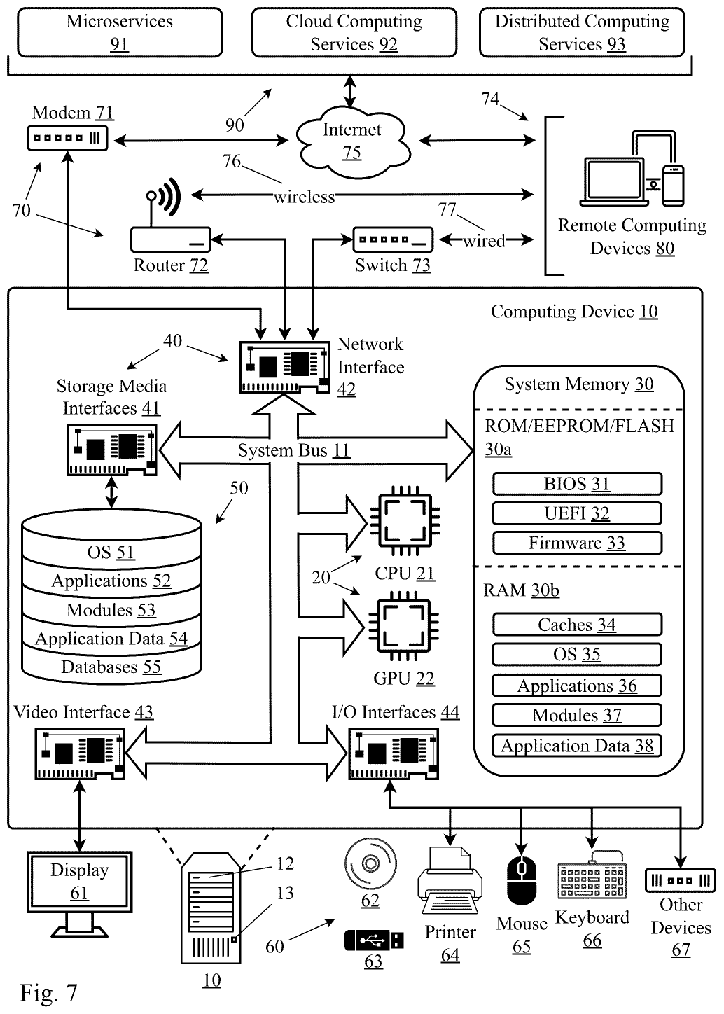

FIG. 7 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally accessible data ports or connections 12 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions. Further, computing device 10 may comprise one or more specialized processors such as a graphics processing unit (GPU) 22 configured to accelerate processing of computer graphics and images via a large array of specialized processing cores arranged in parallel.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed and includes memory types such as read only memory (ROM), electronically-erasable programmable memory (EEPROM), and rewritable solid state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random-access memory (RAM) and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10 to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid-state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, object oriented databases, BOSQL databases, and graph databases.

Applications (also known as computer software or software applications) are sets of programming instructions designed to perform specific tasks or provide specific functionality on a computer or other computing devices. Applications are typically written in high-level programming languages such as C++, Java, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing devices and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network. Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks

(LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices.

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90.

In an implementation, the disclosed systems and methods may utilize, at least in part, containerization techniques to execute one or more processes and/or steps disclosed herein. Containerization is a lightweight and efficient virtualization technique that allows you to package and run applications and their dependencies in isolated environments called containers. One of the most popular containerization platforms is Docker, which is widely used in software development and deployment. Containerization, particularly with open-source technologies like Docker and container orchestration systems like Kubernetes, is a common approach for deploying and managing applications. Containers are created from images, which are lightweight, standalone, and executable packages that include application code, libraries, dependencies, and runtime. Images are often built from a Dockerfile or similar, which contains instructions for assembling the image. Dockerfiles are configuration files that specify how to build a Docker image. Systems like Kubernetes also support containerd or CRI-O. They include commands for installing dependencies, copying files, setting environment variables, and defining runtime configurations. Docker images are stored in repositories, which can be public or private. Docker Hub is an exemplary public registry, and organizations often set up private registries for security and version control using tools such as Hub, JFrog Artifactory and Bintray, Github Packages or Container registries. Containers can communicate with each other and the external world through networking. Docker provides a bridge network by default but can be used with custom networks. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, main frame computers, network nodes, virtual reality or augmented reality devices and wearables, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP, gRPC, or message queues such as Kafka. Microservices 91 can be combined to perform more complex processing tasks.

Cloud computing services 92 are delivery of computing resources and services over the Internet 75 from a remote location. Cloud computing services 92 provide additional computer hardware and storage on as needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over the Internet on a subscription basis.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power. These services enable parallel processing, fault tolerance, and scalability by distributing tasks across multiple nodes.

Although described above as a physical device, computing device 10 can be a virtual computing device, in which case the functionality of the physical components herein described, such as processors 20, system memory 30, network interfaces 40, and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

The skilled person will be aware of a range of possible modifications of the various aspects described above. Accordingly, the present invention is defined by the claims and their equivalents.

What is claimed is:

1. A system for selecting a random entity with a fuzzy blocklist capability, comprising:
a computing system comprising a memory and a processor; and
a range editor comprising a plurality of programming instructions that, when operating on the processor, causes the computing system to:
receive data from a plurality of databases, the plurality of databases comprising at least a plurality of entities;
index the plurality of entities with an index engine into a plurality of chunks comprising a start value, an end value, and a length which is difference between an absolute value of the difference between the start value and the end value;
separate the plurality of chunks with a data chunker into either a plurality of desired chunks or a plurality of blocked chunks;
pass the plurality of desired chunks into a data normalization engine which normalizes the lengths of each desired chunk into normalized lengths;
send the plurality of desired chunks and their normalized lengths to a random number generator which selects a random desired chunk;
select a value from the selected random desired chunk using a value selector.

2. The system of claim 1, further comprising a potential address map which receives entities directly or from the plurality of databases and creates a map of potential entities according to a plurality of rules.

3. The system of claim 2, wherein the index engine indexes the map of potential entities into the plurality of chunks.

4. The system of claim 3, wherein the random number generator selects a random desired chunk with a probability based on its normalized length.

5. A method for selecting a random Internet Protocol address with a fuzzy blocklist capability, comprising the steps of:
receiving data from a plurality of databases, the plurality of databases comprising at least a plurality of entities;
indexing the plurality of entities with an index engine into a plurality of chunks comprising a start value, an end value, and a length which is difference between an absolute value of the difference between the start value and the end value;
separating the plurality of chunks with a data chunker into either a plurality of desired chunks or a plurality of blocked chunks;
passing the plurality of desired chunks into a data normalization engine which normalizes the lengths of each desired chunk into normalized lengths;
sending the plurality of desired chunks and their normalized lengths to an advanced random number generator which selects a random desired chunk;
selecting a value from the selected random desired chunk using a value selector.

6. The method of claim 5, further comprising a potential address map which receives entities directly or from the plurality of databases and creates a map of potential entities according to a plurality of rules.

7. The method of claim 6, wherein the index engine indexes the map of potential entities into the plurality of chunks.

8. The method of claim 7, wherein the random number generator selects a random desired chunk with a probability based on its normalized length.

9. Non-transitory, computer-readable storage media having computer-executable instructions embodied thereon that, when executed by one or more processors of a computing system employing an asset registry platform for selecting a random entity with a fuzzy blocklist capability, cause the computing system to:
receive data from a plurality of databases, the plurality of databases comprising at least a plurality of entities;
index the plurality of entities with an index engine into a plurality of chunks comprising a start value, an end value, and a length which is the difference between an absolute value of the difference between the start value and the end value;
separate the plurality of chunks with a data chunker into either a plurality of desired chunks or a plurality of blocked chunks;
pass the plurality of desired chunks into a data normalization engine which normalizes the lengths of each desired chunk into normalized lengths;
send the plurality of desired chunks and their normalized lengths to an advanced random number generator which selects a random desired chunk;
select a value from the selected random desired chunk using a value selector.

10. A system for selecting a random entity with a fuzzy blocklist capability, comprising one or more computers with executable instructions that, when executed, cause the system to:
receive data from a plurality of databases, the plurality of databases comprising at least a plurality of entities;
index the plurality of entities with an index engine into a plurality of chunks comprising a start value, an end value, and a length which is the difference between an absolute value of the difference between the start value and the end value;
separate the plurality of chunks with a data chunker into either a plurality of desired chunks or a plurality of blocked chunks;
pass the plurality of desired chunks into a data normalization engine which normalizes the lengths of each desired chunk into normalized lengths;
send the plurality of desired chunks and their normalized lengths to an advanced random number generator which selects a random desired chunk;
select a value from the selected random desired chunk using a value selector.
